(19) United States
(12) Patent Application Publication
(10) Pub. No.: US 2007/0267897 A1
(43) Pub. Date: Nov. 22, 2007

(54) Open Roof Construction for a Vehicle and Method for Opening It

(75) Inventor: Frank Hendricus Gerardus Van De Logt, Bergen (NL)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Inalfa Roof Syst6ems Group B.V., Ah Venray (NL)

(21) Appl. No.: 10/591,380

(22) PCT Filed: Mar. 1, 2005
(86) PCT No.: PCT/EP05/50886

§ 371 Date: May 9, 2007

(30) Foreign Application Priority Data
Mar. 1, 2004 (EP) 04100798.0

(51) Int. Cl. B60J 7/047

(52) U.S. Cl. 296/211

(57) ABSTRACT

In an open roof construction for a vehicle a closure means for a roof opening comprises a number of separate closure panels, whereas a sunshade means comprises a number of separate sunshade panels. In an opened position of the open roof construction the closure panels and sunshade panels, respectively, define separate stacks one behind the other in the longitudinal direction of the vehicle.

### CROSS-REFERENCE TO RELATED APPLICATION

This Application is a Section 371 National Stage Application of International Application No. PCT/EP2005/050886, filed Mar. 1, 2005 and published as WO 2005/082659 A1 on Sep. 9, 2005, in English.

### BACKGROUND

The invention firstly relates to an open roof construction for a vehicle, comprising a roof opening provided in a stationary roof part, a closure means which is movable between a position for closing said roof opening and a position for opening said roof opening, and a sunshade means which is movable between a position overlapping said roof opening and a position freeing said roof opening, wherein the closure means comprises a number of separate closure panels positioned, in the closing position of the closure means, one behind the other in the longitudinal direction of the vehicle, whereas the sun-shade means comprises a number of sunshade panels positioned, in the overlapping position of the sunshade means, one behind the other in the longitudinal direction of the vehicle, and wherein the closure panels as well as the sunshade panels assume a stacked position one on top of the other behind the roof opening when positioned in the opening and freeing position, respectively.

Such an open roof construction is known from DE-A-19851366. In this known open roof construction the closure means comprises a forward and rearward closure panel, whereas the sunshade means comprises a forward and rearward sunshade panel. In the opening position of the closure means and freeing position of the sunshade means these four panels are moved below the stationary roof part in such a manner, that all four panels are positioned one on top of the other. When such a configuration is used in an open roof construction, in which the closure means and sunshade means comprise a larger number of separate panels, the overall height of the stack of panels in the opening and freeing position of the closure means and sun-shade means, respectively, would increase considerably, which may cause problems because of a reduced height of the passenger compartment of the vehicle.

### SUMMARY

An aspect of the present invention is to provide an open roof construction of the type referred to above, in which said disadvantage is prevented in a simple, yet nevertheless effective manner.

Thus, in accordance with this aspect of the present invention an open roof construction or assembly for a vehicle, having a roof opening provided in a stationary roof part, includes a closure means which is movable between a position for closing said roof opening and a position for opening said roof opening, and a sunshade means which is movable between a position overlapping said roof opening and a position freeing said roof opening, wherein the closure means comprises a number of separate closure panels positioned, in the closing position of the closure means, one behind the other in the longitudinal direction of the vehicle, whereas the sunshade means comprises a number of sunshade panels positioned, in the overlapping position of the sunshade means, one behind the other in the longitudinal direction of the vehicle, and wherein the closure panels as well as the sunshade panels assume a stacked position one on top of the other behind the roof opening when positioned in the opening and freeing position, respectively. In addition, the closure panels and sunshade panels, respectively, define separate stacks one behind the other in the longitudinal direction of the vehicle.

Because the closure panels at one hand and the sunshade panels at the other hand define separate stacks positioned one behind the other, the overall height of such stacks may be limited, such that no problems arise with respect to the inner height of the passenger compartment of the vehicle.

It is noted, that is not strictly necessary, that only one stack of closure panels and only one stack of sunshade panels are formed. It might be possible, that the closure panels are arranged in more than one stack. This also applies to the sunshade panels. However, in one embodiment, the closure panels will define only one stack, and the sunshade panels will define only one other stack.

In accordance with an embodiment of the open roof construction according to the present invention, the stack of stacked sunshade panels is positioned behind the stack of stacked closure panels. Such a positioning of a stack of closure panels will simplify an operating mechanism needed for moving the respective panels towards their respective positions. In most cases, stacking the closure panels only will be possible after removing the sunshade panels, i.e. after moving the sunshade panels towards their freeing position (in which they define the stack of sunshade panels). When, in such a case, the stack of closure panels would be positioned behind the stack of sunshade panels, the closure panels would have to bypass the stack of sunshade panels in some manner, which then would complicate the operating mechanism considerably.

The complexity of any operating mechanism may be limited, when in accordance with yet another embodiment of the open roof construction according to the present invention, in the stack of sunshade panels the rearmost sunshade panel is positioned at the top and the foremost sunshade panel is positioned at the bottom, with intermediate sunshade panels assuming corresponding positions in the stack.

The same applies, when, in accordance with still another embodiment of the open roof construction in accordance with the present invention, in the stack of closure panels the rearmost closure panel is positioned at the bottom and the foremost closure panel is positioned at the top, with intermediate closure panels assuming corresponding positions in the stack.

Another aspect of the invention secondly refers to a method for opening an open roof construction for a vehicle of the type comprising a roof opening provided in a stationary roof part, a closure means which is movable between a position for closing said roof opening and a position for opening said roof opening, and a sunshade means which is movable between a position overlapping said roof opening and a position freeing said roof opening, wherein the closure means comprises a number of separate closure panels positioned, in the closing position of the closure means, one behind the other in the longitudinal direction of the vehicle, whereas the sunshade means comprises a number of sunshade panels positioned, in the overlapping position of the sunshade means, one behind the other in the longitudinal direction of the vehicle, wherein the closure panels as well as the sunshade panels are moved towards a stacked position one on top of the other behind the roof opening when being moved towards the opening and freeing position, respectively.

In accordance with this aspect of the present invention, said method includes stacking the closure panels and sunshade panels, respectively, in separate stacks one behind the other in the longitudinal direction of the vehicle.

Further embodiments of the method according to the present invention are defined in subclaims 6-8.

### BRIEF DESCRIPTION OF THE DRAWINGS

Hereinafter the invention will be elucidated referring to the drawings, in which an embodiment of an open roof construction according to the present invention is illustrated.

### DETAILED DESCRIPTION

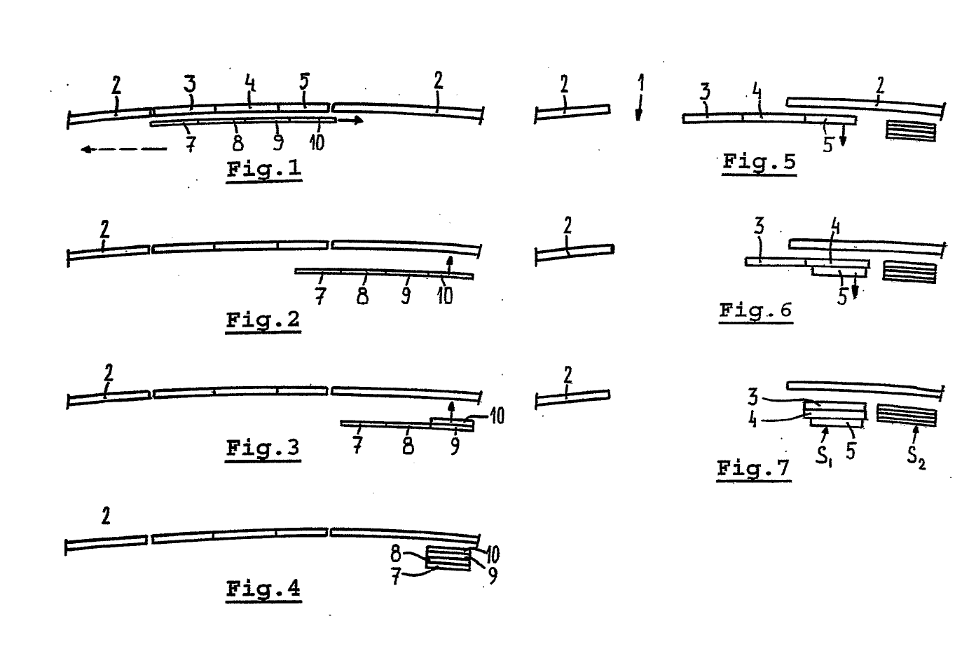

FIGS. 1-7 show schematically an open roof construction in accordance with the present invention at successive stages during opening it.

The open roof construction for a vehicle in accordance with the present invention comprises a roof opening 1 (best seen in FIG. 5) provided in a stationary roof part 2. In FIG. 1 said roof opening 1 is closed by means of a closure means comprising three separate closure panels 3, 4, 5 positioned one behind the other in the longitudinal direction 6 of the vehicle. The use of the phrase ‘separate’ does not necessarily mean that the panels are not interconnected.

The closure means 3, 4, 5 is movable between the closing position illustrated in FIG. 1 (in which said roof opening 1 is fully closed) and an opening position (illustrated in FIG. 7) in which the roof opening is fully opened.

Positioned below the closure means is a sunshade means comprising four separate sunshade panels 7-10 positioned one behind the other in the longitudinal direction 6 of the vehicle. Also here, the use of the phrase ‘separate’ does not necessarily mean that the panels are not interconnected. The sunshade means 7-10 is movable between the position illustrated in FIG. 1 in which it overlaps the roof opening 1 and the position illustrated in FIG. 7, in which it frees the roof opening 1.

As clearly illustrated in FIG. 7, the closure panels 3-5 and sunshade panels 7-10 define separate stacks S₁ and S₂ one behind the other in the longitudinal direction 6 of the vehicle. Specifically, stack S₁ comprising the closure panels 3-5 is positioned ahead stack S₂ comprising the sunshade panels 7-10.

When opening the open roof construction illustrated in FIG. 1, firstly the sunshade means (sunshade panels 7-10) are moved rearwardly (FIG. 1). When the rearmost sunshade panel has reached the location of the future stack S₂, it is moved upwardly, whereas the remaining sunshade panels 7-9 are moved further until the next sunshade panel 9 is positioned below sunshade panel 10 (FIG. 3).

This process is repeated until all four sunshade panels 7-10 are positioned in stack S₂ (FIG. 4), in which stack S₂ the rearmost sunshade panel 10 is positioned at the top and the foremost sunshade panel 7 is positioned at the bottom of the stack.

Next the closure means (closure panels 3-5) are lowered and moved rearwardly, until the rearmost closure panel 5 has reached the position of the future stack S₁ (FIG. 5). Then, the rearmost closure panel 5 is lowered and the remaining closure panels 4 and 3 are moved further until closure panel 4 is positioned above closure panel 5 (FIG. 6). Finally the assembly of closure panels 4 and 5 is lowered further and the remaining closure panel 3 is positioned on top of this assembly. This completes stack S₁ comprising closure panels 3-5 (FIG. 7).

For again closing the open roof construction the described succession of steps will be reversed.

The invention is not limited to the embodiment described before which may be varied widely within the scope of the invention as defined by the appending claims. For example, when the closure means and/or sunshade means comprises a large number of separate panels, more than one stack of each type of panels may be formed when moving the open roof construction towards its open position.

1. Open roof construction for a vehicle, comprising a roof opening provided in a stationary roof part, a closure means which is movable between a position for closing said roof opening and a position for opening said roof opening, and a sunshade means which is movable between a position overlapping said roof opening and a position freeing said roof opening, wherein the closure means comprises a number of separate closure panels positioned, in the closing position of the closure means, one behind the other in the longitudinal direction of the vehicle, whereas the sunshade means comprises a number of sunshade panels positioned, in the overlapping position of the sunshade means, one behind the other in the longitudinal direction of the vehicle, and wherein the closure panels as well as the sunshade panels assume a stacked position one on top of the other behind the roof opening when positioned in the opening and freeing position, respectively, wherein the closure panels and sunshade panels, respectively, define separate stacks one behind the other in the longitudinal direction of the vehicle.

2. Open roof construction according to claim 1, wherein the stack of stacked sunshade panels is positioned behind the stack of stacked closure panels.

3. Open roof construction according to claim 2, wherein in the stack of sunshade panels the rearmost sunshade panel is positioned at the top and the foremost sunshade panel is positioned at the bottom, with intermediate sunshade panels assuming corresponding positions in the stack.

4. Open roof construction according to claim 2, wherein in the stack of closure panels the rearmost closure panel is positioned at the bottom and the foremost closure panel is positioned at the top, with intermediate closure panels assuming corresponding positions in the stack.

5. Method for opening an open roof construction for a vehicle of the type comprising a roof opening provided in a stationary roof part, a closure means which is movable between a position for closing said roof opening and a position for opening said roof opening, and a sunshade means which is movable between a position overlapping said roof opening and a position freeing said roof opening, wherein the closure means comprises a number of separate closure panels positioned, in the closing position of the closure means, one behind the other in the longitudinal direction of the vehicle, whereas the sunshade means comprises a number of sunshade panels positioned, in the overlapping position of the sunshade means, one behind the other in the longitudinal direction of the vehicle, wherein the closure panels as well as the sunshade panels are moved towards a stacked position one on top of the other behind the roof opening when being moved towards the opening and freeing position, respectively wherein the closure panels and sunshade panels, respectively, are stacked in separate stacks one behind the other in the longitudinal direction of the vehicle.

6. Method according to claim 5, wherein firstly the stack of stacked sunshade panels is formed and next, ahead of said stack of sunshade panels, the stack of closure panels is formed.

7. Open roof construction according to claim 6, wherein the sunshade panels are successively stacked from top to bottom in such a way that the rearmost sunshade panel will be positioned at the top and the foremost sunshade panel will be positioned at the bottom.

8. Open roof construction according to claim 6, wherein the closure panels are successively stacked from bottom to top in such a way that the rearmost closure panel will be positioned at the bottom and the foremost closure panel will be positioned at the top.
